(19) United States
(12) Patent Application Publication
(10) Pub. No.: US 2010/0065631 A1
(43) Pub. Date: Mar. 18, 2010

(54) MERCHANDISE CHECKOUT TERMINAL

(75) Inventor: Pierre Orlewski, Ettlebruck (LU)

Correspondence Address: CANTOR COLBURN, LLP, 20 Church Street, 22nd Floor, Hartford, CT, 06103, US

(73) Assignee: IEE INTERNATIONAL ELECTRONICS AND ENGINEERING S.A., Echternach (LU)

(21) Appl. No.: 12/516,812

(22) PCT Filed: Nov. 20, 2007
(86) PCT No.: PCT/EP2007/062556

§ 371 Date: May 29, 2009

(30) Foreign Application Priority Data
Nov. 29, 2006 (EP) 06125046.0

(51) Int. Cl. G06K 15/00

(52) U.S. Cl. 235/383

(57) ABSTRACT

A merchandise checkout terminal is equipped with an article scanning device. The article scanning device comprises a bar code reader and a quality sensor interrogator for interrogating a quality sensor integrated into a packaged perishable article and retrieving quality information concerning the packaged perishable article.

### TECHNICAL FIELD OF THE INVENTION

The invention generally relates to a merchandise checkout terminal (sometimes also referred to as point of sale), such as e.g. a cahier's desk, a checkout counter or a self-checkout machine, comprising a merchandise scanning device (hereinafter referred to as article scanning device).

### BRIEF DESCRIPTION OF RELATED ART

Perishable goods, such as fruits and vegetables, meat products or seafood wrapped under modified atmosphere have experienced and still experience growing popularity. It is expected that this trend will even increase in the next years.

In general, modified atmosphere packaging allows reducing proliferation of pathogenic agents, which allows increasing the products shelf life and may help to reduce the use of preservatives. In modified atmosphere packaging technique, the perishable article is not surrounded by air (N₂ 78%; O₂ 21%; Ar 0.93%; CO₂ 0.03%) but by a product-specific gas mixture, which typically has very different oxygen content than atmospheric air. The gas mixture used and the characteristics of the packaging film may depend upon the kind of the packed good. Highly insulating barrier films (having low gas permeability) are typically used for wrapping non-respiring products such as e.g. meat, fish and cheese, so that the inner gas mixture remains substantially constant over the shelf life of these products. For fruits and vegetables, the permeability of the packaging film for O₂ and/or CO₂ may be adapted in such a way that the respiration of the product is slowed down and that an equilibrium modified atmosphere establishes around the packed product.

With the increasing amount of articles packaged under modified atmosphere, monitoring the freshness and avoiding spoilage of these articles becomes a challenging issue for retailers. Nowadays, testing the quality of wrapped goods is mostly done by analysing a limited number of package samples. Sampling inspection cannot guarantee, however, that all the packaged goods still meet the quality criteria. Another disadvantage is the loss of a certain fraction of the packaged products, as the testing procedure currently existing for that purpose destroys at least the package. Moreover, inspecting the goods directly on the shelves is not practicable with such a technique. A very promising method that allows determining the freshness of a packed article in a non-destructive way is to associate a dedicated sensor to the wrappings in such a way that it can be remotely interrogated. The involved sensors may be implemented in barely perceptible way for the end user (consumer). U.S. Pat. No. 5,407,829 discloses, for instance, a method for controlling the quality of packaged organic substances e.g. food and drugs. The organic substance is sealed together with an optical sensor element in a gas-tight manner, so that the optical sensor element is in contact with the gas phase between the organic product and the packing material. A change in the composition of the gas phase, e.g. the a change of the content in O₂, CO₂, H₂S, NH₃, or the like, leads to a change in an optical property, preferably in colour or in fluorescence of the sensor element. This change in optical property is then detected visually or opto-electronically. WO 2006/010768 A1 discloses a device for interrogating an optical sensing probe based upon a CMOS or CCD imager or a CMOS or CCD sensor matrix.

While the above-described technique makes testing the quality of random samples of packed perishable articles feasible in a non-destructive and comparatively inexpensive way, it still remains a problem to control the quality of all the articles.

### BRIEF SUMMARY OF THE INVENTION

The invention proposes a merchandise checkout terminal equipped with an article scanning device. The article scanning device comprises a bar code reader and, according to an important aspect of the invention, a quality sensor interrogator for interrogating a quality sensor associated with or integrated into a packaged perishable article and retrieving quality information concerning the packaged perishable article. For the purposes of the present, the term “quality information” encompasses information concerning the freshness state of the wrapped good, the constitution of the inner atmosphere of the wrapping, the presence or absence of potentially dangerous agents, the integrity of the package and like parameters. Accordingly, the quality sensor interrogator may comprise e.g. a freshness sensor interrogator, an integrity sensor interrogator and/or a contamination sensor interrogator for interrogating respectively a freshness sensor, an integrity sensor and/or a contamination sensor associated with an article. As will be appreciated, bar code readers (or bar code scanners) have been commercially used in merchandise checkout terminals since the mid-1970s and nowadays belong to the standard equipment in supermarkets, food retailers, grocery stores, and the like. The bar code of virtually every article that is sold, is scanned with the bar code reader in order to retrieve the pricing information on the article. The article scanning device according to the invention is therefore appropriate for controlling the quality of virtually every article provided with a quality sensor element. With this device, the risk that spoilt (or otherwise contaminated) goods or articles with deficient product insulation leave the point of sale is considerably reduced. For instance, each time an article that does not meet certain quality criteria is scanned, a warning, e.g. in audible or visible form, may be output, instructing the cashier not to hand over the article to the customer.

The merchandise checkout terminal may be the last point in the supply chain before the customer, at which the quality (e.g. the freshness and/or the integrity of the wrapping) of perishable articles can be tested. Doing this thoroughly, one could achieve testing of 100% of the perishable articles despite of quite complex supply chains, thereby providing maximum safety for the customer or end user.

Preferably, the quality sensor interrogator comprises an energy transmitter for transmitting, an interrogation signal to the quality sensor and an energy receiver for receiving a response signal from the quality sensor, the response signal carrying quality information with respect to the wrapped article. Obviously, the type of the quality sensor interrogator depends on the choice of quality sensors and vice-versa. The quality sensors may, for instance, include smart RFID (Radio Frequency Identification) tags and/or optical sensor elements (e.g. optodes) based e.g. on dynamic fluorescence quenching. It should be noted that the sensors suitable for the invention are sensors that can be interrogated remotely, which in this case does not mean that there is necessarily a great distance between the sensor and the interrogator but rather that no direct mechanical contact between them is required. The interrogation and response signals may include e.g. an electromagnetic signal (IR, visible and/or UV light signal, RF signal, etc.). By remotely interrogating the quality sensor elements, testing becomes easier, more reliable and the expenses related to quality control (e.g. for labs, analytical equipment and trained personnel) might be considerably reduced.

In case of smart RFID tags, the interrogator preferably comprises an RF transceiver for sending an RF electromagnetic pulse to the tag and receiving an RF electromagnetic response pulse from the tag. In case of an optical sensor element, the interrogator preferably comprises a light source for emitting light at a wavelength capable of exciting the fluorescent material of the optical sensor element and a light detector for detecting the fluorescence light emitted in return by the optical sensor element. The light detector may e.g. detect fluorescence light intensity, fluorescence intensity decay time, fluorescence light polarisation and/or fluorescence light phase. The theory of fluorescence quenching is well known in the art and needs not to be discussed herein. According to a preferred embodiment, the interrogator comprises a CMOS imager or a CCD imager, as disclosed e.g. in WO 2006/010768 A1.

According to a preferred embodiment of the invention, the bar code reader and the quality sensor interrogator are arranged in such a way that their fields of view at least partially overlie one another. For the purposes of the present, the term “field of view” designates a spatial region within which the bar code reader and the quality sensor interrogator, for a given position and orientation thereof, are able to detect and read a bar code or a quality sensor element, respectively. For sake of distinction between the two fields of view, the field of view of the bar code reader is herein also referred to as first field of view and the field of view of the interrogator as second field of view. Most preferably, the first field of view is substantially covered by the second field of view. In this case, it is ascertained that an article whose bar code is currently scanned is within the detection range of the quality sensor interrogator and that, if the article wears a quality sensor, the quality information is read and evaluated before the article leaves the point of sale. In the simplest embodiment, overlapping fields of view might be the only precaution against the possibility of a perishable article leaving the point of sale uncontrolled. It should be noted that the article scanning device might be integrated into a cahier's desk and/or into a separate handheld device.

In a preferred embodiment, however, the quality sensor interrogator is responsive to information collected by the bar code reader. The bar code of an article corresponds to an identification number (or identification key), by which information on the article, e.g. its designation, price, weight, etc., can be retrieved from a database. For each article in the database, one could add a flag that indicates whether the quality of the article is to be checked when the latter is about to leave the point of sale. Information relating to quality, e.g. whether a quality test should be done, tolerance ranges for oxygen concentration or other parameters, etc., could also be encoded directly into the bar code, so that the bar code reader can retrieve it without having to query the database. This preferred embodiment of the invention is advantageously used in combination with the process as described hereinafter. The bar code of an article is read and the necessary pieces of information, including price and article designation, are retrieved from the article database. Additionally, the flag indicating whether a quality check shall be done is evaluated. If quality control is prescribed, the quality sensor interrogator is activated. In case a quality sensor is within the field of view of the interrogator, the latter may evaluate whether the quality of the packaged article is okay. A warning may be issued if the quality criteria are not met. A warning (possibly an additional warning) may also be issued if interrogating the quality sensor is not successful, e.g. because the sensor element is placed on the wrong side of the article. If the interrogation of the quality sensor is successful and if the article passes the quality test, the article is put on the bill and the article scanning device is made ready for scanning the bar code of the next article. As will be appreciated, this embodiment may make it virtually impossible to checkout an article the quality of which has not been tested and deemed as satisfying.

It should be noted that there could be more than one quality sensor element associated with perishable articles. This may be the case, for instance, if one wishes to determine more than one parameter pertaining to the quality of a single article, e.g. the O₂ concentration and the ammonia concentration of a modified-atmosphere package, or the CO₂ concentration and the H₂S concentration of such a package. It can also be the case, if different quality sensors or combinations thereof are used for different kinds of articles. Under such circumstances, it is preferable that the article scanning device comprises more than one quality sensor interrogator or a quality interrogator capable of interrogating the different types of quality sensors used. Those skilled will understand that in case of multiple quality sensors it is highly preferable that the article database contains information regarding the sensor or sensors associated with the different articles.

Depending on the type of the perishable article, different contamination agents and/or parameters may be remotely detected. For instance, the quality sensor and the quality sensor interrogator may be configured so as to test for the following characteristics or contamination agents:

constitution of inner atmosphere (MAP packaging): amount of oxygen, carbon dioxide, nitrogen, moisture, etc.;

integrity of article package, e.g. whether there are pin holes in the packaging foil enabling penetration of the package by micro-organisms such as e.g. bacteria or fungi;

temperature, e.g. the maximum temperature to which the packaged good has been subjected;

undesirable and/or pathogenic bacteria, germs and/or exotoxins, e.g. Salmonella, Escherichia coli, Staphylococcus aureus, Clostridium botulinum, Listeria monocytogenes, Shigella, Streptococcus, etc. parasite spores, e.g. Trichinella, Toxoplasma gondii, taenia, etc.;

viruses, e.g. rotaviruses, Norwalk viruses, hepatitis viruses, etc.;

prions;

fungi or mildew;

naturally occurring food endotoxins, e.g. grayanotoxin (rhodotoxin), mushroom toxins, etc.;

exotoxins secreted by bacteria whose presence in foodstuff might be considered acceptable up to a certain amount, e.g. colicin of E. coli;

persistent organic pollutants (POPs), e.g. dioxins, polychlorinated biphenyls, etc.;

specific aromatic compounds resulting from food maturation or ageing (e.g. in cheese or fish).

metal pollutants, e.g. mercury, lead, cadmium and other heavy metals;

(excess) undesired inorganic compounds like sulphides, phosphates, etc.;

radiation level, especially in the case of mushrooms, mushroom-based or mushroom-containing products.

To emit a warning, e.g. an audible or optical one, in response to the retrieved quality information, the article scanning device advantageously comprises a warning device, equipped e.g. with an electro-acoustic transducer, a blinking light and/or a display on which appears a warning code. More preferably, the article scanning device is configured so as to prevent check-out of a perishable article the quality of which has not been controlled or does not meet the quality criteria, e.g. by automatically blocking that the article is put on the bill. To further increase customer safety, the article scanning device may comprise a marking device for marking the packaged perishable article in response to the retrieved quality information. This marking device may, for instance, be configured so as to put a visible mark on an article that turned out to be improper for being consumed. Such a mark may reduce the likelihood that a customer is inadvertently handed out a spoilt article or that an article withheld at the merchandise checkout terminal is accidentally returned to the shelf. According to a preferred variant, the marking device is configured so as to irreversibly modify (e.g. degrade) the aspect of a packaged article that failed the quality test. Such a permanent mark may be helpful to counter quality claims customers might raise after having left the shop. A permanent mark may also make fraudulent repacking or relabelling of disqualified products more difficult.

Optionally, the marking device may be configured so as to provide the packaged articles with a new “best before” date, based upon the actual quality parameters determined by the interrogator. For liability reasons, the marking device might be configured so as to correct the statistically determined “best before” date only to an earlier date, if necessary, but not to a later one.

According to a somewhat more sophisticated embodiment, the packaged perishable articles include a marker the visible aspect of which can undergo a permanent change in response to activation with the marking device of the article scanning device. The marker could e.g. be transparent or of a first colour before activation, and opaque or of a second, different colour after activation. Activation could e.g. be achieved optically. In this case, the marking device may comprise a flashlamp or another light source (LED, laser, etc.). In simpler embodiments, the marking device may comprise a labelling machine for attaching sticky labels to the packaged article.

### BRIEF DESCRIPTION OF THE DRAWINGS

Further details and advantages of the invention will be apparent from the following detailed description of not limiting embodiments with reference to the attached drawings, wherein:

FIG. 1 is a schematic perspective view of a merchandise checkout terminal equipped with an article scanning device, according to the invention;

FIG. 2 is a perspective view of a packaged perishable article provided with an optically interrogatable quality sensor element and a bar code label;

FIG. 3 is a perspective view of the packaged article of FIG. 2 with an activated marker element;

FIG. 4 is a schematic partial view of an article scanning device comprising a bar code reader and a quality sensor interrogator;

FIG. 5 is a flow diagram illustrating a preferred embodiment of the checkout procedure.

### DETAILED DESCRIPTION OF THE INVENTION

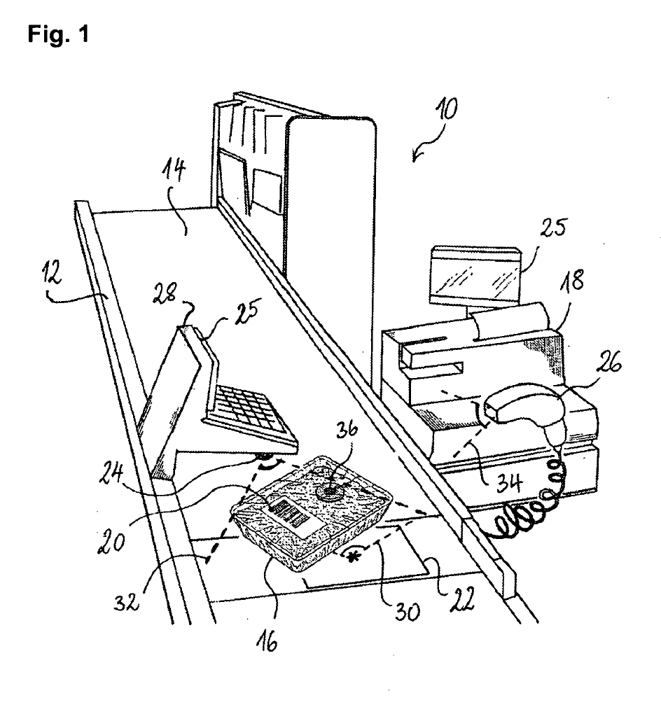

FIG. 1 shows a merchandise checkout terminal, generally indicated at reference numeral 10. The merchandise checkout terminal comprises an elongated counter 12 with a moving belt 14, on which a customer places the articles he or she has collected in their shopping cart. The cashier rings up each article 16 on the computer-based electronic cash register 18 by scanning the article's bar code 20 with the article scanning system 22, 24, 26.

The article scanning system 22, 24, 26 comprises a plurality of article scanning devices, namely the fixed countertop scanning device 22, a fixed upper scanning device 24 (integrated into the overhanging bottom of console 28) and the handheld scanning device 26. Each one of the article scanning devices 22, 24, 26 includes a bar code reader and a quality sensor interrogator (see FIG. 3). The quality of each article about to leave the store thus can be checked at the checkout 10. The latter comprises a warning device to inform the cashier and possibly the customer, if a scanned article does not meet certain predefined quality criteria. Such warning could e.g. appear on one or both of displays 25.

The fields of view of the article scanning devices 22, 24, 26 are schematically indicated at reference numerals 30, 32 and 34. In order not to overload the drawing, the fields of view of the bar code readers and of the quality sensor interrogators are not shown separately. In the illustrated embodiment, however, it is assumed that for each one of the article scanning devices, 22, 24, 26, the respective fields of view substantially overlie one another.

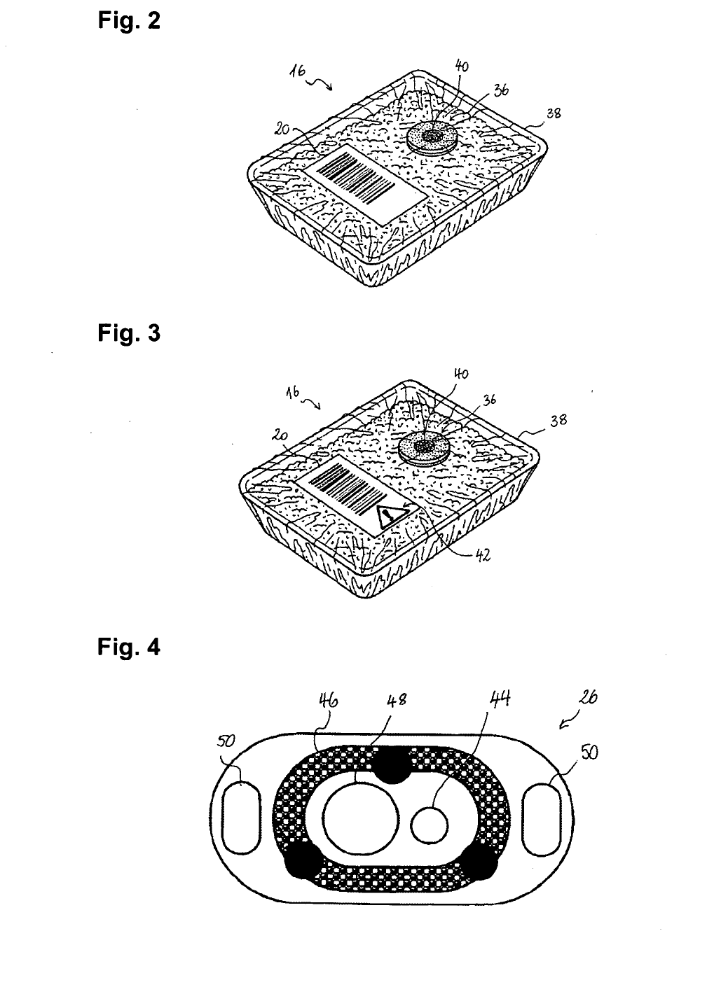

The article 16, e.g. foodstuff packaged under modified atmosphere, as shown in FIG. 2, comprises a disposable optically interrogatable sensor element 36 arranged inside the packaging 38, in proximity of the bar code label 20. The sensor element 36 can be responsive to any of the above-mentioned parameters or compounds, for sake of illustration, we assume here that it is responsive to oxygen concentration. As mentioned above, in modified atmospheres the oxygen concentration is typically lowered in comparison to breathable air, which increases the lifetime of the packaged article. If the package is imperfectly, sealed, oxygen may enter the packaging, which of course decreases the lifetime of the article. With the sensor element 36 and a suitable interrogator, oxygen concentration within the packaged article may be detected. The sensor element 36 comprises an oxygen indicating substance 40, such as a ruthenium compound (e.g. Ru(II)(Dpp)₃, other examples can be found in the relevant literature). Additionally, it may also comprise a substance that is responsive to temperature, such as Oregon Green dye.

As best seen in FIG. 3, the packaged article 16 is provided with a marker 42 on the bar code label 20. According to other embodiments, the marker could also be part of the quality sensor element 36, be provided inside or outside the packaging or as part of the packaging material (e.g. of the packaging foil). The marker 42 comprises an optically sensitive material, which changes its aspect when activated by an appropriate light beam or light flash. In the present example the marker 42 is normally invisible (FIG. 2) and only becomes visible when optically activated (FIG. 3), e.g. by an article scanning device as disclosed herein.

The handheld article scanning device 26 suitable for been used in combination with articles comprising a quality sensor and a marker as shown in FIGS. 2 and 3 is partially depicted in FIG. 4. The article scanning device 26 comprises a bar code reader 44 and a quality sensor interrogator for determining oxygen concentration by measuring certain optical properties of the oxygen indicator 40, e.g. fluorescence lifetime, fluorescence intensity and/or the phase of the fluorescence light. In the illustrated case, the interrogator comprises a light source 46 (e.g. a LED or VCSL illumination unit with filters) configured so as to emit a modulated light signal at the maximum absorption wavelength of the oxygen indicator 40 (about 470 nm for Ru(II)(Dpp)₃). This puts the oxygen indicator substance 40 into an excited state, which decays under the emission of fluorescence light. The above-mentioned properties of the fluorescence light depend on the oxygen partial pressure in the modified atmosphere. The interrogator in this example comprises reader optics 48 (lenses and/or filters associated e.g. with a CMOS or CCD chip) to detect the fluorescence light and measure its properties (e.g. phase, intensity and/or decay). The interrogator further comprises an evaluation unit (not shown), e.g. a microprocessor or an application-specific integrated circuit (ASIC).

The article scanning device also comprises a marking device 50 (e.g. UV flashlamps and/or IR light sources) for activating a marker 42 on a packaged article. The marking device 50 is preferably configured so as to emit light of the maximum absorption wavelength the marker 42. The activation of the marker 42 takes place only if the quality has been determined as unsuitable, e.g. if a value of the measured fluorescence light property is out of a predefined range or exceeds a preset threshold. When activated, the marker becomes visible and indicates that the food contained in the package should not be sold/consumed.

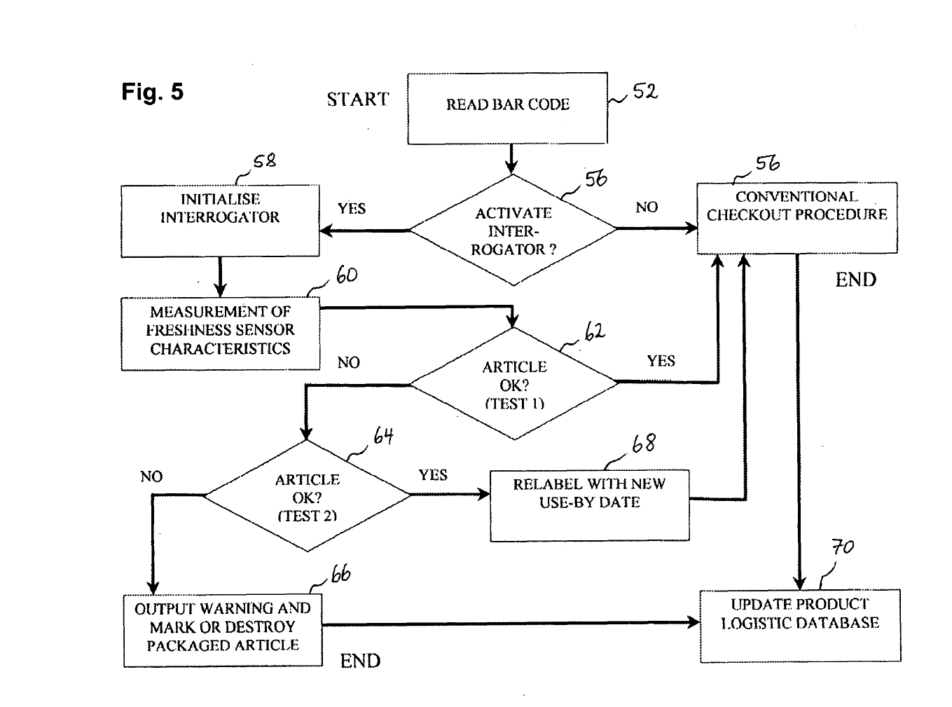

FIG. 5 illustrates a possible procedure to be followed when an article is checked out at merchandise checkout terminal 10. The procedure starts when the cashier brings the bar code of an article into the field of view of one of their bar code readers and when the bar code is read (step 52). Based upon the information contained in the bar code or associated therewith through a database, it is decided, at decision step 54, whether the food quality sensor interrogator is to be activated. For a non-food article, for instance, a quality test may be deemed unnecessary and the information that no such test shall be performed at checkout is associated with the bar code or contained therein. If no quality test is required, the product follows a conventional checkout procedure (step 56).

If a quality test is prescribed for an article, the quality sensor interrogator is initialised according to the information associated with the bar code or contained therein (step 58). If, for instance, it is derived from the bar code that a CO₂ test and an O₂ have to be carried out, the quality sensor interrogator activates those of its components that address that task or adjusts a multi-tasking component. The quality information relating to the article under examination is retrieved by measuring certain characteristics of the quality sensor(s) of the article (step 60) and compared with stored threshold values or with threshold values retrieved via the bar code (step 62). If this comparison reveals that the article meets the quality requirements, the article further undergoes the conventional checkout procedure (step 56).

If the comparison however reveals that the article does not meet the quality requirements, it would be a first option to provide a warning signal that the article must not be sold and/or to mark the article as improper for sale or use.

In FIG. 5, however, a second, more sophisticated option is illustrated. In this case, the quality criteria of step 62 are relatively severe, so that an article that fails at comparison 62 is not necessarily spoilt. After comparison 62, the measured values of step 60 are compared to less severe threshold values (step 64), which indicate whether the article can still be sold. The less severe threshold values may also be stored values or values retrieved from the scanned bar code. If the measured values are outside the range prescribed at step 64, a warning signal is emitted and the article is marked to show that it is improper for sale/use (step 66). The product logistic database is updated in consequence (step 70). If the measured values meet the requirements of step 64, the article is still deemed of satisfying quality but having a shortened lifetime. Accordingly, the article is provided with a new use-by date (step 68) and then undergoes conventional checkout procedure at 56.

1. Merchandise checkout terminal including an article scanning device, said article scanning device comprising
a bar code reader
and a quality sensor interrogator to interrogate an optical sensor element associated with or integrated into a packaged perishable article as a quality sensor and to retrieve quality information concerning said packaged perishable article, said quality sensor interrogator comprising a light source to emit light at a wavelength capable of exciting fluorescent material of such optical sensor element and a light detector to detect fluorescence light emitted in return by such optical sensor element.

2. Merchandise checkout terminal according to claim 1, wherein said bar code reader has a first field of view, wherein said quality sensor interrogator has a second field of view and said bar code reader and said quality sensor interrogator are arranged in such a way that said first and second fields of view at least partially overlie one another.

3. Merchandise checkout terminal as claimed in claim 1, wherein said quality sensor interrogator is responsive to information collected by said bar code reader.

4. Merchandise checkout terminal as claimed in claim 1, comprising a warning device capable of emitting an audible or optical warning in response to said retrieved quality information.

5. Merchandise checkout terminal as claimed in claim 1, comprising a marking device for marking said packaged perishable article in response to said retrieved quality information.

6. Merchandise checkout terminal as claimed in claim 1, wherein said quality sensor interrogator comprises a freshness sensor interrogator.

7. Merchandise checkout terminal as claimed in claim 1, wherein said quality sensor interrogator comprises an integrity sensor interrogator.

8. Merchandise checkout terminal as claimed in claim 1, wherein said quality sensor interrogator comprises a contamination sensor interrogator.

9. Merchandise checkout terminal as claimed in claim 1, wherein said article scanning device is so configured as to prevent checkout of a perishable article, the quality of which has not been controlled or does not meet a quality criterion.

10. Method of conditionally checking out a packaged perishable article using a merchandise checkout terminal including an article scanning device, said article scanning device comprising a bar code reader and a quality sensor interrogator, said method comprising
reading a bar code of said article;
retrieving information from an article database using said bar code, said information indicating whether a quality check is prescribed for said article;
evaluating whether said quality check is prescribed;
if said quality check is prescribed, attempting to interrogate a quality sensor associated with or integrated into said article, and,
if said interrogation of said quality sensor is successful and said article passes said quality check, putting said article on a bill and making said article scanning device ready for scanning a bar code of a next article, or,
if said interrogation of said quality sensor is unsuccessful or if said interrogation reveals that a quality criterion is not met, issuing a warning.

11. The method as claimed in claim 10, wherein said quality sensor interrogator comprises a light source to emit light at a wavelength capable of exciting fluorescent material of an optical sensor element associated with or integrated into said article as said quality sensor, and a light detector for detecting fluorescence light emitted in return by said optical sensor element.

12. The method as claimed in claim 10, wherein, if interrogation of said quality sensor is unsuccessful or if said interrogation reveals that a quality criterion is not met, preventing checkout of said article.

13. The method as claimed in claim 10, wherein, if said interrogation reveals that a quality criterion is not met, marking said article.

14. The method as claimed in claim 10, wherein said article is provided with an earlier “best before”-date or an earlier “use by”-date based upon said quality sensor interrogation.
